(19) United States
(12) Patent Application Publication
(10) Pub. No.: US 2011/0264615 A1
(43) Pub. Date: Oct. 27, 2011

(54) LOCATION SOURCE DETERMINATION

(75) Inventors: Rajeev D. Rajan, San Diego, CA (US); Arnold Jason Gum, San Diego, CA (US); Vineet Mittal, San Diego, CA (US)

(73) Assignee: QUALCOMM Incorporated, San Diego, CA (US)

(21) Appl. No.: 12/765,677

(22) Filed: Apr. 22, 2010

(51) Int. Cl. G06N 5/02; G01S 19/42

(52) U.S. Cl. 706/47; 342/357.25; 706/52

(57) ABSTRACT

The subject matter disclosed herein relates to systems, methods, etc. for location source determination. For example implementations, a method is described in which a request for a location of a user that is associated with a logical identifier is obtained. A determination may be made as to which type(s) of information (e.g., geographical information, calendar information, online information, etc.) is (are) to be used to obtain a location of the user based at least in part on one or more rules that are associated with the user. Other example implementations are described herein.

### BACKGROUND

1. Field

The subject matter disclosed herein relates to determining a source for providing a location.

2. Information

Determining a person's location may be beneficial in a number of situations. For example, during turn-by-turn navigational sessions, a person's location is used as a current starting point for providing subsequent directional instructions. One approach to determining a person's location uses satellite position system (SPS) technology, but alternative approaches may be used instead. In other situations, a person's location may be shared to provide some service.

In other words, some location-based applications involve sharing an individual's location with a third party. Example applications include, but are not limited to, identifying a proximate business or service, providing notification alerts of heavy traffic or emergencies, disseminating location-relevant advertising, communicating a location to an associate (e.g., acquaintance, co-worker, family member, friend, etc.), and so forth. Implementing such applications may involve the transfer of an individual's location to a third party.

When there is a possibility that one's location may be transferred to a third party, safety and confidentiality issues arise. Unfortunately, existing applications that may share a person's location have insufficient, if any, privacy controls. Consequently, an individual whose locations are being mapped or tracked may often have little practical control over how or to whom the location information is being transferred.

### BRIEF DESCRIPTION OF THE FIGURES

Non-limiting and non-exhaustive aspects, features, etc. will be described with reference to the following figures, wherein like reference numerals refer to like parts throughout the various figures.

FIG. 1 is a block diagram of an example scheme for providing a location indication obtained from a location source from among multiple location sources according to an implementation.

FIG. 2 depicts multiple example location sources, such as geographical, calendar, and online sources, according to an implementation.

FIG. 3 illustrates example aspects of geographical information for a physical location according to an implementation.

FIG. 4 illustrates example aspects of calendar information for a scheduled location according to an implementation.

FIG. 5 illustrates example aspects of online information for a virtual location according to an implementation.

FIG. 6 is a block diagram illustrating an example scheme for determining a location source from calendar information or geographical information based on one or more rules according to an implementation.

FIG. 7 is a block diagram illustrating an example scheme for determining a location source from online information or calendar information (or geographical information) based on one or more rules according to an implementation.

FIG. 8 is a flow diagram illustrating an example method for providing a location indication in conjunction with a location source determination according to one implementation.

FIG. 9 is a flow diagram illustrating an example method for providing a location indication in conjunction with a location source determination according to another implementation.

FIG. 10 is a block diagram illustrating an example mechanism for implementing location source selection rules according to an implementation.

FIG. 11 depicts an example environment and multiple example devices in which location source determination may be implemented, according to an implementation.

FIG. 12 is a schematic diagram illustrating an example device, according to an implementation, that may implement one or more aspects for location source determination.

### SUMMARY

For example implementations, a method is provided in which a request for a location of a user that is associated with a logical identifier may be obtained. A determination may be made as to which type(s) of information (e.g., geographical information, calendar information, online information, etc.) is (are) to be used to obtain a location of the user based at least in part on one or more rules that are associated with the user. It should be appreciated, however, that this is merely an example implementation and that other implementations are described herein and may be implemented without deviating from claimed subject matter.

### DETAILED DESCRIPTION

Reference throughout this Specification to “a feature,” “one feature,” “an example,” “one example,” and so forth means that a particular feature, structure, characteristic, etc. described in connection with the feature and/or example is relevant to at least one feature and/or example of claimed subject matter. Thus, the appearances of a phrase such as “in one example,” “an example,” “in one feature,” “a feature,” “in an example implementation,” and so forth in various places throughout this Specification are not necessarily all referring to the same feature, example, and/or example implementation. Furthermore, the particular features, examples, structures, characteristics, etc. may be combined in one or more example implementations, example systems, and so forth.

As indicated above, knowledge of an individual's location by another person may be considered a confidentiality issue and/or a matter of actual safety. Consequently, an individual may want to control who is provided knowledge of their location. One approach to controlling such knowledge is to limit who is permitted to be provided an individual's location. Although existing location privacy settings may permit the blocking of a transmission of a location, the fact that a location has not been provided might be glaringly obvious to the location requester. Such a denial of a location request may have social implications. There may be times, therefore, when it might be undesirable or inappropriate to openly deny a person's request for an individual's location. For instance, an individual's spouse or professional associate may have expectations regarding access to the individual's location at certain times of the day. Moreover, an individual may simultaneously be associated with two or more locations, such as a physical location and a virtual location. Alternatively, an individual's true location may not be available at a time of a request, or a requester may want to check an individual's expected location.

Thus, it may not be preferable to openly deny a particular person's request for an individual's location and/or an individual may be simultaneously associated with multiple locations. In certain example implementations as described herein, in response to receipt of a request for an individual's location, a determination may be made as to which type or types of location information may be used to obtain an individual's location. Example types of location information include, but are not limited to, geographical information that may provide a physical location, calendar information that may provide a scheduled location, online information that may provide a virtual location, combinations thereof, and so forth. An individual may be empowered to establish, change, or otherwise adjust one or more rules that facilitate selection of at least one type of location information that is to be used to obtain an individual's location.

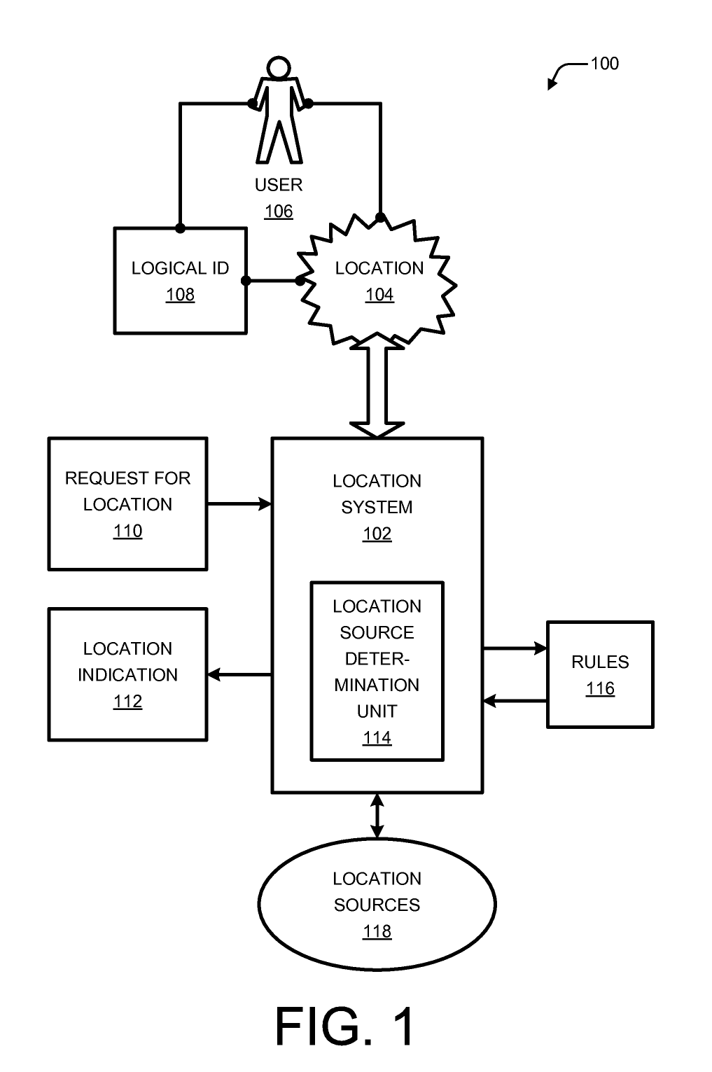

FIG. 1 is a block diagram of an example scheme 100 for providing a location indication 112 obtained from a location source from among multiple location sources 118 according to an implementation. As illustrated, scheme 100 may include a location system 102, a user 106 that is affiliated with a location 104, and a logical identifier (ID) 108. Also shown is a request for location 110, a location indication 112, one or more rules 116, and multiple location sources 118. Location system 102 may include a location source determination unit 114. Location system 102 may be realized fully or partially as discrete/fixed logic circuitry, hardware, firmware, software, any combination thereof, and so forth, just to name a few examples.

In certain example implementations, user 106 may be associated with one or more locations 104. User 106 may also be associated with at least one logical ID 108. Examples of logical IDs 108 may include, but are not limited to, a username, a handle identification, an avatar name, an email address, a phone number, an instant message identifier, some combination thereof, and so forth. User 106 may also be associated with rules 116. Alternatively and/or additionally, an object or general asset (not explicitly shown) may be associated with one or more locations 104 and/or at least one logical ID 108. Such an object or general asset may also be associated with rules 116. In example implementation(s) that include objects or general assets, a source for obtaining their location may be determined as described herein.

In an example operation, location source determination unit 114 may select at least one location source from location sources 118 based on rules 116. A selected location source may be used to obtain a location 104. More specifically, location system 102 may receive a request for location 110 from a requesting entity (not shown). A request for location 110 may include or otherwise correspond to a logical ID 108 that is associated with user 106. Based on one or more rules 116 that may be associated with user 106 and/or logical ID 108, location source determination unit 114 may determine which location source(s) of multiple location sources 118 are to be used to obtain a location 104.

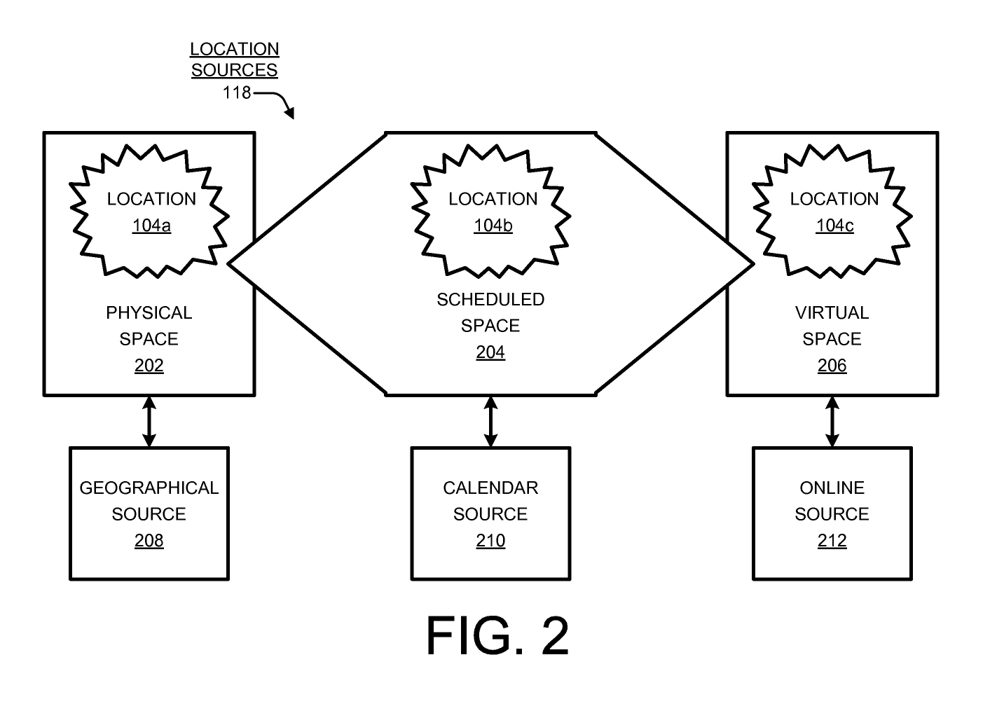

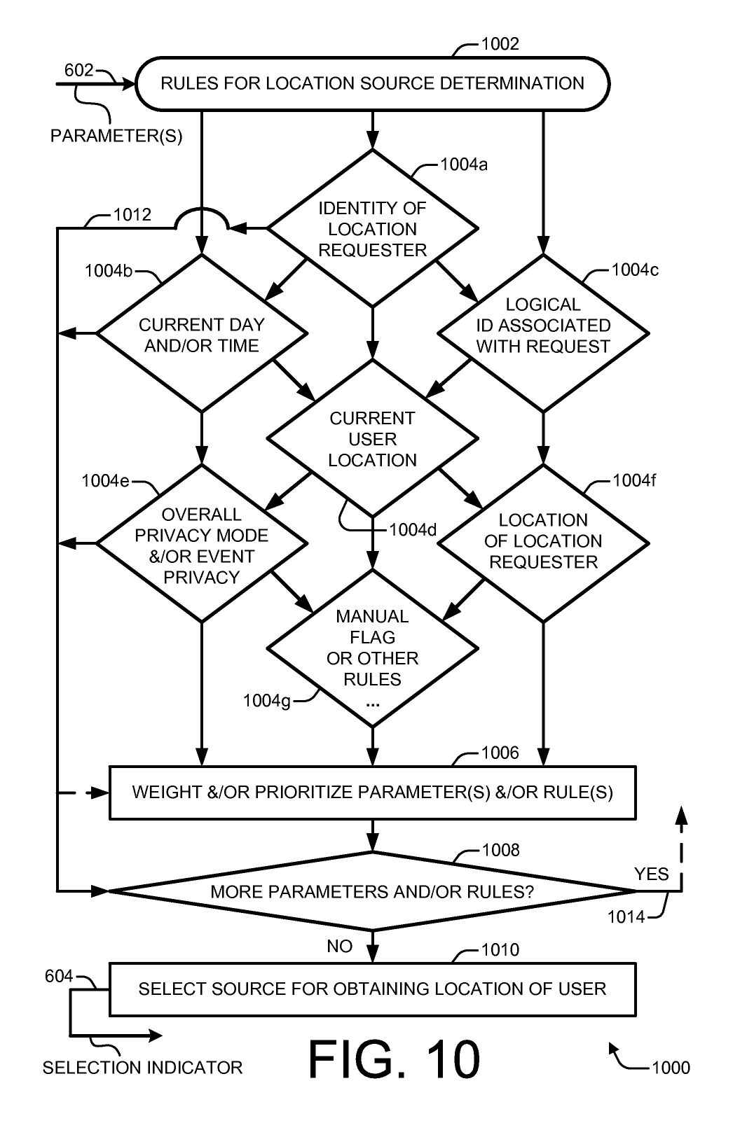

Although rules 116 are shown as being separate from location source determination unit 114 (as well as separate from location system 102), rules 116 may alternatively be incorporated as part of location source determination unit 114 (and/or part of location system 102). Example implementations for one or more rules 116 are described herein below with particular reference to FIG. 10. Example implementations for location sources 118 are described herein below with particular reference to FIG. 2.

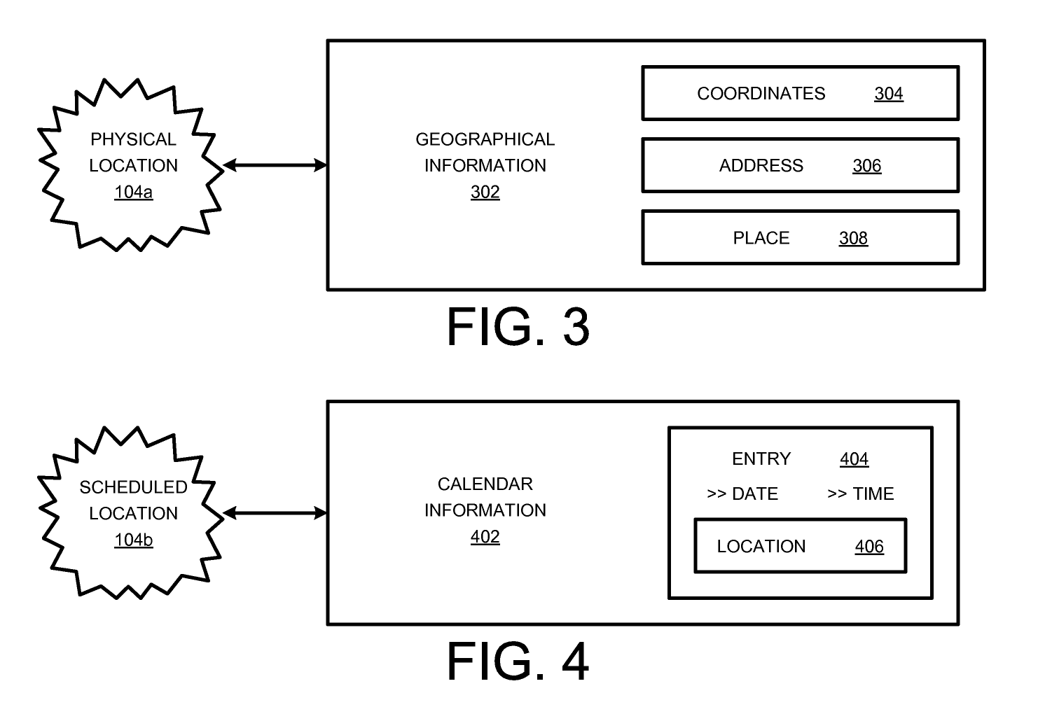

After selection of at least one location source by location source determination unit 114, location system 102 may obtain location 104 (e.g., from the selected location source). A location indication 112, which represents obtained location 104, may be sent from location system 102. Location system 102 may send location indication 112 to, for example, a requesting entity (not shown) that originally submitted request for location 110. Example implementations for location indication 112 are described herein below with particular reference to FIGS. 3-5.

FIG. 2 depicts multiple example location sources 118 according to an implementation. As illustrated, there are three example location sources 118. In certain example implementations, example location sources may include, but are not limited to: a geographical source 208, a calendar source 210, and an online source 212. Each of these sources may correspond to a space (e.g., a physical space 202, a scheduled space 204, a virtual space 206, etc.) having potential locations 104. A given location system 102 (e.g., of FIG. 1) may use one or more geographical sources 208, one or more calendar sources 210, one or more online sources 212, any combination thereof, and so forth.

Geographical sources 208 may correspond to a physical space 202. Calendar sources 210 may correspond to a scheduled space 204. Online source 212 may correspond to a virtual space 206. Physical space 202 may include physical locations 104a. Scheduled space 204 may include scheduled locations 104b. Virtual space 206 may include virtual locations 104c. However, other location sources and spaces may be used and/or implemented without departing from claimed subject matter.

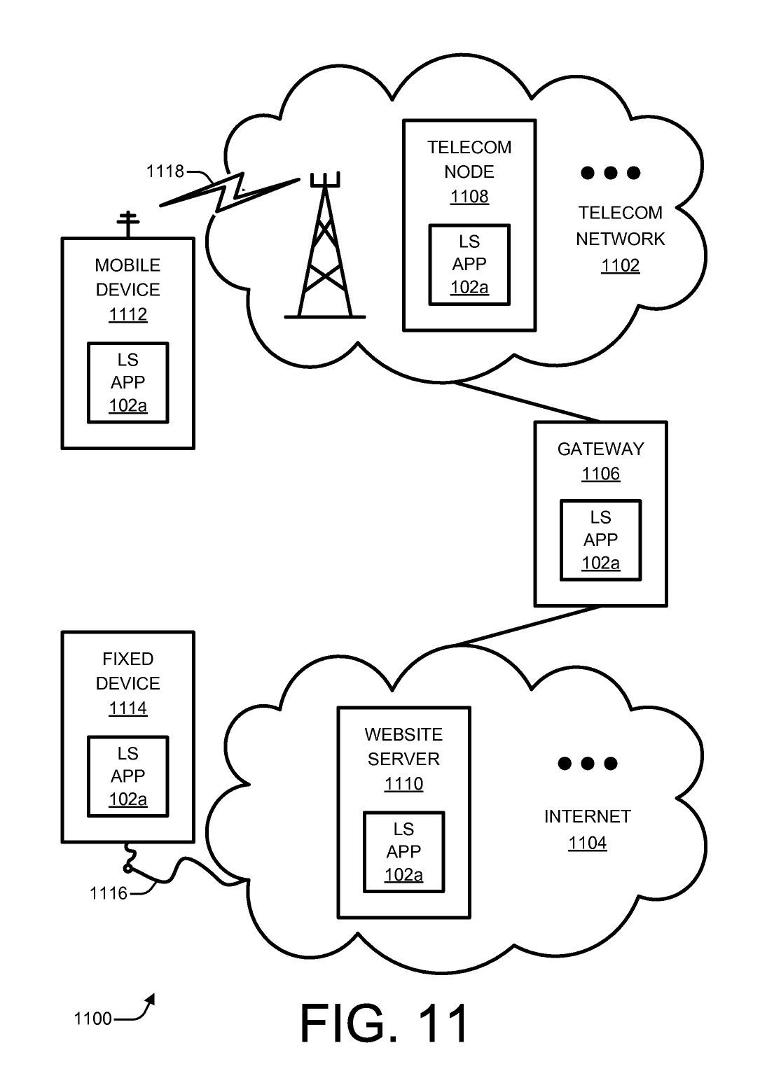

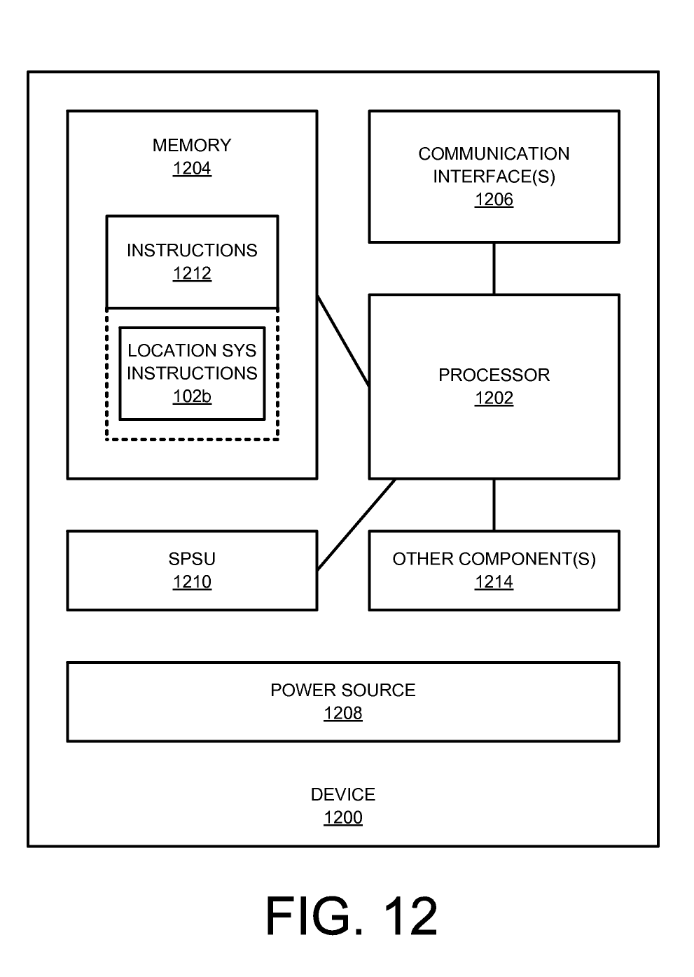

For example implementations, geographical sources 208 may comprise any one or more sources that are capable of providing a physical location 104a. Example geographical sources 208 may include, but are not limited to: a satellite positioning system (SPS), communication with a cellular type wireless system, communication with a wireless access point (e.g., a Wi-Fi “hotspot”, a WiMAX connection point, etc.), a physical connection to a network, a combination thereof, and so forth. An SPS, for example, may determine a physical location to differing degrees of precision or granularity. Additional example SPS concepts and implementations are described further herein below with particular reference to FIGS. 11 and 12.

With wireless communications (e.g., such as those between a handset and infrastructure of a wireless network), a relatively general location may be determined based merely on being within a usable range between a transmitter and a receiver (e.g., a maximum antenna transmission/reception range (MAR), a known potential range of a given wireless cell, etc.). A relatively specific location may be determined based on a calculation of a distance between a network node and a wireless device. A still more specific location may be determined by “trilaterating” a wireless device's location using two or more nodes of a wireless network. A wired connection to a network (e.g., to a business' local area network (LAN)) may provide a general place of location (e.g., a company's campus) of a device that is currently connected by wire. Other location-determining strategies with wireless or wired communication may alternatively be implemented without departing from claimed subject matter. Example aspects for physical locations 104a are described further herein below with particular reference to FIG. 3.

For example implementations, calendar sources 210 may comprise any one or more sources that are capable of providing a scheduled location 104b. For example, a calendar source 210 may be any table, database, grid, portion thereof, combination thereof, etc. that links at least one date and/or time to one or more locations. Calendar sources 210 may link dates and/or times with at least one identified location in one or more entries (e.g., a location may correspond to a scheduled entry at a given date and/or time). An identified location may therefore be quite general to relatively general, relatively specific to quite specific, anywhere in between, and so forth, just to name a few examples. As represented by the hexagonal shape of scheduled space 204 that overlaps physical space 202 and virtual space 206, scheduled locations 104b may correspond to a physical location, a virtual location, and so forth, just to name a few examples. A calendar source 210 may be stored or otherwise situated at a device that is implementing a location system 102 (of FIG. 1), may be stored remotely from such a device implementing a location system 102, and so forth, just to name a few examples. Hence, a location system 102 may access a calendar source 210 that is local to a given device and/or access a calendar source 210 that is remote from the given device. A calendar source may be organized, presented, accessible, etc. in any manner without departing from claimed subject matter. Example aspects for scheduled locations 104b are described further herein below with particular reference to FIG. 4.

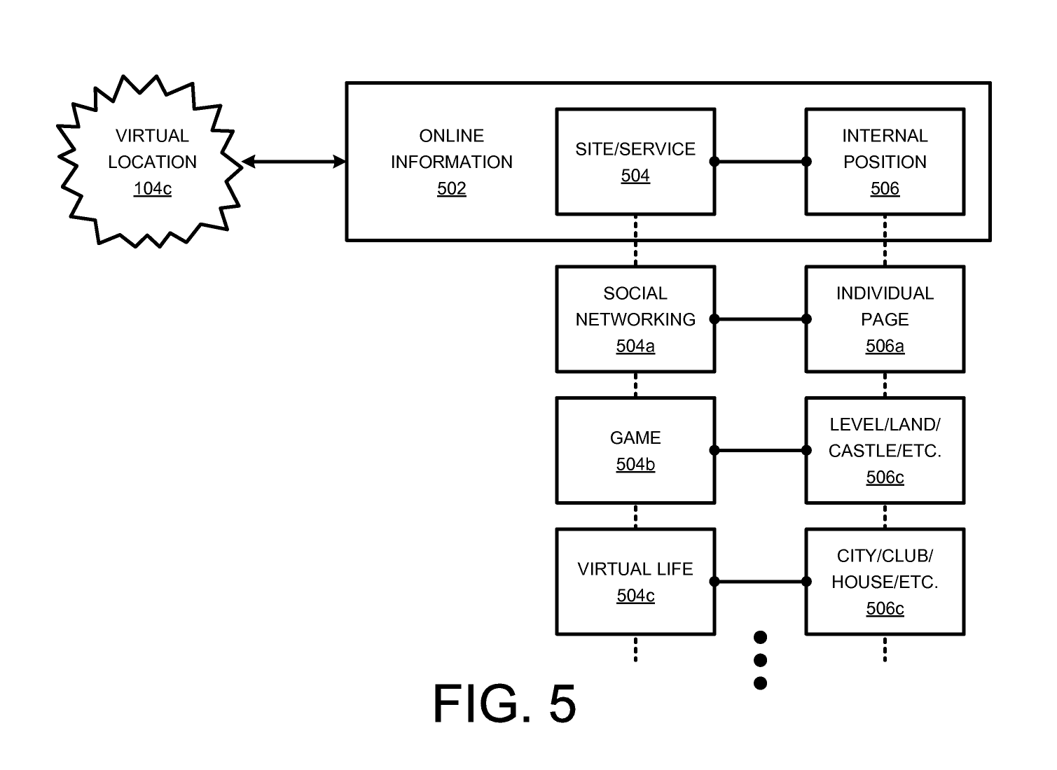

For example implementations, online sources 212 may comprise any one or more sources that are capable of providing a virtual location 104c. Virtual locations 104c may be realized, for example, as electronic destinations on any one or more networks (e.g., locations in cyberspace). Examples of online sources 212 may include, but are not limited to, those sources that provide access to: network resources, such as an internet (e.g., web) or other network site and/or service generally; particular position(s) that are internal to a given internet site and/or service; combinations thereof; and so forth. As another example, an online source 212 may comprise at least a portion of a presence server. Example aspects for virtual locations 104c are described further herein below with particular reference to FIG. 5.

FIG. 3 illustrates example aspects of geographical information 302 for physical locations 104a according to an implementation. A geographical source 208 (e.g., of FIG. 2) may produce and/or provide geographical information 302. A location system 102 (e.g., of FIG. 1) may use geographical information 302 to obtain a physical location 104a. Geographical information 302 may be organized in any manner, stored in one or multiple locations, exposed for internal or external access in any one or more of multiple ways, and so forth, just to name a few examples.

In certain example implementations, geographical information 302 may include sufficient information to obtain a physical location 104a. Hence, geographical information 302 may include, by way of example but not limitation, coordinates 304, an address 206, a place 308, a general geographical area, some combination thereof, and so forth. Coordinates 304 may comprise, for example, coordinates from an SPS, latitude and longitude coordinates, a combination thereof, and so forth. An address 306 may comprise, for example, a postal or other street address. A place 308 may comprise, for example, a personal home, a building name, a neighborhood, a city, a county, a state, a country, a geographical landmark, an indoor location, an outdoor location, a combination thereof, and so forth. Geographical information 302 may alternatively and/or additionally include other information without departing from claimed subject matter.

FIG. 4 illustrates example aspects of calendar information 402 for scheduled locations 104b according to an implementation. A calendar source 210 (e.g., of FIG. 2) may produce and/or provide calendar information 402. A location system 102 (e.g., of FIG. 1) may use calendar information 402 to obtain a scheduled location 104b. Calendar information 402 may be organized in any manner, stored in one or multiple locations, exposed for internal or external access in any one or more of multiple ways, and so forth, just to name a few examples.

In certain example implementations, calendar information 402 may include one or more entries 404. Such an entry may correspond to at least one date during a year and/or at least one time during a day. An entry 404 may comprise an event, a meeting, a task, etc. that is associated with a date and/or time. Alternatively and/or additionally, an entry 404 may comprise a particular date and/or time that is associated with an event, a meeting, a task, etc. An entry 404 may also correspond to (e.g., comprise, be associated with, etc.) a location 406. Particular days, dates, and/or times may thus be linked to locations. Similarly, particular locations may be linked to days, dates, and/or times. When selecting between multiple entries having at least partially overlapping times, entry differentiation may be based at least partly on a tag associated with an entry or entries (e.g., a real planned location versus an alternate false location), on an actual location (e.g., selecting a real or a false location), and so forth, just to name a few examples. Similarly, in other embodiments, different types of entries such as genuine/real calendar entries versus fictitious/fabricated calendar entries may be separated into different calendars. Calendar information 402 or a configuration of calendar information 402 may differ from these example implementations without departing from claimed subject matter.

As indicated above with regard to scheduled space 204 (of FIG. 2), location 406 may take at least any of the forms for physical locations 104a (e.g., as described herein above with particular reference to FIG. 3), any of the forms for virtual locations 104c (e.g., as described herein below with particular reference to FIG. 5), some combination thereof, and so forth, just to name a few examples. A user may enter location 406 for a given entry 404 in any manner. For example, a user may enter location 406 manually. Alternatively, a user may copy and paste an address, a location name, etc. into a field corresponding to location 406 for an entry 404. Also, a user may point (e.g., click, press, etc.) to a location on a map to enter location 406. As another example, when a user is present at a particular virtual location, a user may enter it into location 406 (e.g., using a right-click command, a menu option, a keyboard combination, etc.). Furthermore, a user may journey to a physical location, command a device to determine SPS coordinates, and have those coordinates entered as location 406. Such determined SPS coordinates may also be “bookmarked” for future use. Other entry mechanisms may alternatively be implemented for location 406 without departing from claimed subject matter.

FIG. 5 illustrates example aspects of online information 502 for virtual locations 104c according to an implementation. An online source 212 (e.g., of FIG. 2) may produce and/or provide online information 502. A location system 102 (e.g., of FIG. 1) may use online information 502 to obtain a virtual location 104c. Online information 502 may be organized in any manner, stored in one or multiple locations, exposed for internal or external access in any one or more of multiple ways, and so forth, just to name a few examples.

In certain example implementations, online information 502 may include information that indicates a virtual location at which a user is currently logged-in or otherwise interacting. Hence, online information 502 may comprise a network site and/or service 504. In other words, online information 502 may include a name, address, or other identifier of a network site and/or service, such as a uniform resource locator (URL) of a website. Alternatively and/or additionally, online information 502 may comprise an internal position 506. An internal position 506 may indicate a particular portion or destination of a given network site and/or service 504.

Network sites and/or services 504 and specific internal positions 506 may comprise any virtual location 104c. Examples of such sites/services 504 and internal positions 506 may include, by way of example but not limitation: a social network site 504a and an individual page 506a thereof; a game 504b and a level, land, town, castle, dungeon, tavern, etc. 506b thereof; a virtual life entertainment destination 504c and a city, club, house, etc. 506c thereof; some combination thereof, and so forth. Social networking 504a may include, in addition to relatively “pure” social networking sites that are designed to facilitate interaction between and among friends, family, co-workers, associates, business contacts, etc., a general communication site/service and a specific chat room thereof, a blog consolidation site/service and a specific blog thereof, and so forth. However, online information 502 may differ from these example implementations without departing from claimed subject matter.

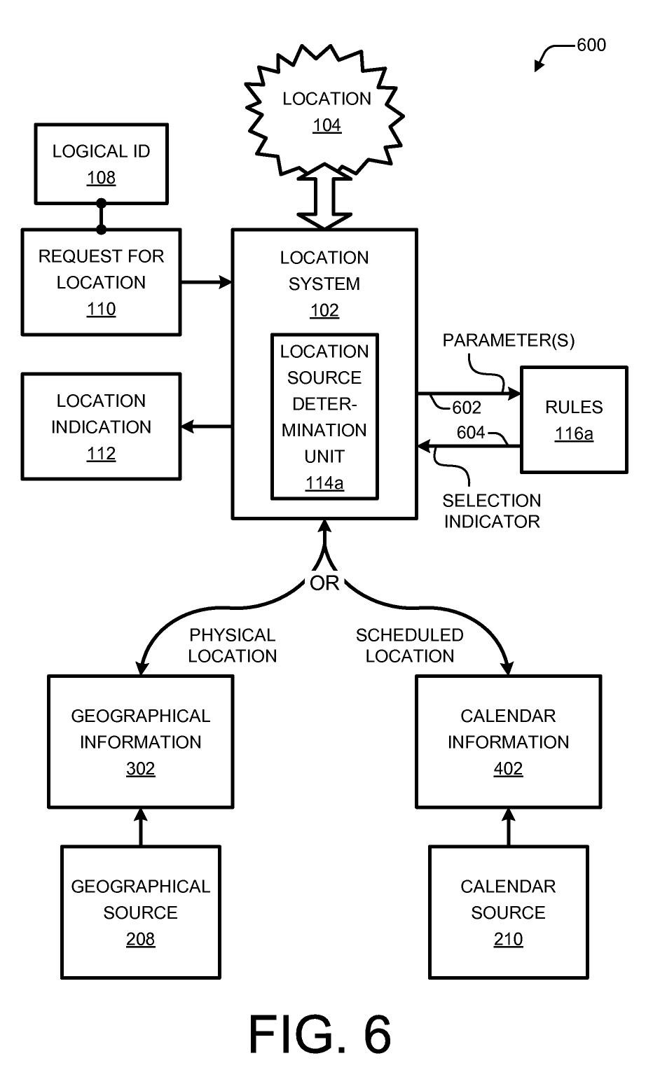

FIG. 6 is a block diagram illustrating an example scheme 600 for determining a location source from calendar information 402 or geographical information 302 based on one or more rules 116a according to an implementation. As illustrated, scheme 600 may include a location system 102, a location 104 (of a user 106 (e.g., of FIG. 1)), a logical ID 108, a request for location 110, a location indication 112, and one or more rules 116a. Also shown are geographical information 302, a geographical source 208, calendar information 402, and a calendar source 210. Location system 102 may include a location source determination unit 114a.

In certain example implementations, location system 102 may receive from a submitting entity a request for location 110, which may include or otherwise correspond to logical ID 108. Logical ID 108 may be associated with a user 106 (e.g., of FIG. 1) and/or a location 104. Location system 102 may obtain location 104 responsive to logical ID 108 of request for location 110. Location source determination unit 114a may determine which source or sources are to be used to obtain location 104. To make this determination, location source determination unit 114a may consult or otherwise use one or more rules 116a.

In an example implementation as shown for scheme 600 in FIG. 6, location source selection may be made between geographical information 302 and calendar information 402 to obtain a physical location or a scheduled location, respectively. However, location source determination unit 114a, in conjunction with rules 116a, may alternatively select from among three or more location sources. For example implementations, geographical source 208 may produce and/or provide geographical information 302. Similarly, calendar source 210 may produce and/or provide calendar information 402. Geographical information 302 and/or calendar information 402 may correspond to logical ID 108 and/or user 106 (e.g., of FIG. 1).

A location source (e.g., a geographical source 208, a calendar source 210, etc.) may be separate from where its corresponding location information (e.g., geographical information 302, calendar information 402, etc.) may be stored. For example, a geographical source 208 may comprise an SPS unit at a hand-held wireless device, but its corresponding geographical information 302 (e.g., a set of SPS coordinates) may be stored at a wireless node and/or server within a network in conjunction with a location system 102. As another example, a calendar source 210 may be a web-based service provider of email and calendaring functions, but its corresponding calendar information 402 may be stored or partially stored at a hand-held wireless device in conjunction with a location system 102. Hence, location system 102 may be co-located with any (e.g., from none to all) of geographical source 208, calendar source 210, geographical information 302, calendar information 402, and so forth. By way of example only, a given device may include location system 102 and geographical source 208 (e.g., to ascertain geographical information 302), but such a device may remotely access calendar information 402 from a calendar source 210. Also by way of example only, a different given device may access network-based geographical information 302, but such a different device may include local calendar information 402. Still other devices may have local access to both or neither of geographical information 302 and calendar information 402. Other combinations for other devices may be implemented without departing from claimed subject matter. Different example device implementations are described further herein below with particular reference to FIGS. 11 and 12.

In an example operation, location source determination unit 114a may apply at least one parameter 602 to rules 116a. Parameter(s) 602 may comprise any one or more parameters, which may be implemented automatically, may be specified by a user, may be set by a service provider, established by an operator, some combination thereof, and so forth, just to name a few examples. By way of example only, a parameter 602 may comprise an identity of an entity submitting a request for location 110, a time of day when a location request is received, a current location of a user when a request is received, a combination thereof, and so forth. Additional examples and implementations for parameters 602 and rules 116 are described herein below with particular reference to FIG. 10.

Once parameter(s) 602 are applied to rules 116a, rules 116a may return or otherwise provide a selection indicator 604 to location source determination unit 114a. Selection indicator 604 may indicate which one (or ones) of multiple location sources is (or are) to be used to obtain a location 104 of a user. Location system 102 may select a location source based at least partially on selection indicator 604. For example, if selection indicator 604 indicates geographical information 302 (or, equivalently, geographical source 208), location system 102 may access geographical information 302 (or, equivalently, access geographical source 208) to obtain a physical location. Alternatively, if selection indicator 604 indicates calendar information 402 (or, equivalently, calendar source 210), location system 102 may access calendar information 402 (or, equivalently, access calendar source 210) to obtain a scheduled location.

After obtaining location 104 (e.g., physical location 104a or scheduled location 104b (e.g., of FIGS. 2, 3, and 4)), obtained location 104 may be sent as part of or in association with location indication 112. Request for location 110 and/or location indication 112 may be received and/or transmitted by wire, by trace, wirelessly, etc., just to name a few examples. An identification of the source of the provided location may be included as part of or otherwise accompany location indication 112. For example, a physical location may be tagged with an indication that the provided location is from current SPS coordinates. Alternatively, a scheduled location may be tagged with an indication that the provided location was retrieved from calendar information.

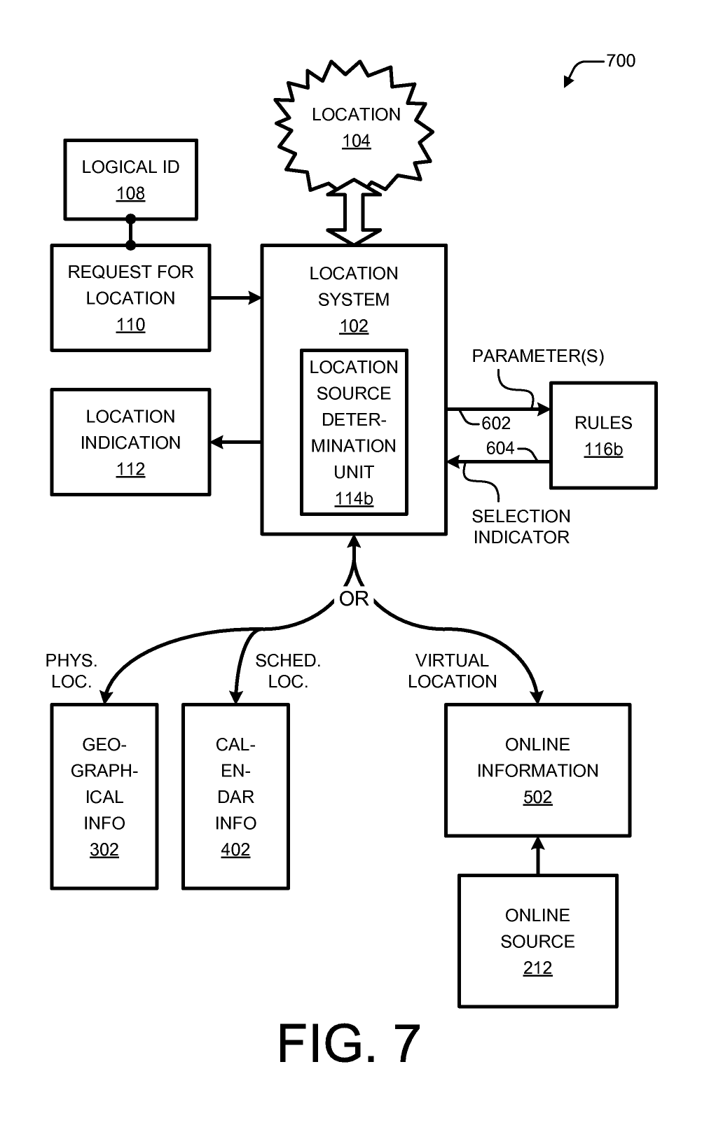

Although a single calendar source 210 and corresponding calendar information 402 are illustrated in FIG. 6 (and in FIG. 7 as described below), a single user may be associated with multiple instances of calendar information 402. For example, calendar information 402 may include two separate calendars with different schedule entries. Alternatively, calendar information 402 may include a single calendar with two sets of schedule entries (e.g., at least one date-time range may have two separate entries, each with possibly its own and different location). In such cases, evaluation of rules 116 may also select between different instances of calendar information 402. For instance, it may be determined which schedule entry from at least two schedule entries, which have an overlapping date-time range, is to be used to obtain a location of a user based at least in part on rules 116a that are associated with the user.

FIG. 7 is a block diagram illustrating an example scheme 700 for determining a location source from online information 502 or calendar information 402 (or geographical information 302) based on one or more rules 116b according to an implementation. As illustrated, scheme 700 may include a location system 102, a location 104 (of a user 106 (e.g., of FIG. 1)), a logical ID 108, a request for location 110, a location indication 112, and one or more rules 116b. Also shown are geographical information 302, calendar information 402, online information 502, and an online source 212. Location system 102 may include a location source determination unit 114b.

In certain example implementations, location system 102 may receive from a submitting entity a request for location 110, which may include or otherwise correspond to logical ID 108. Logical ID 108 may be associated with a user 106 and/or a location 104. Location system 102 may obtain location 104 responsive to logical ID 108 of request for location 110. Location source determination unit 114b may determine which source or sources are to be used to obtain location 104. To make this determination, location source determination unit 114b may consult or otherwise apply one or more rules 116b.

In an example implementation as shown for scheme 700 in FIG. 7, location source selection may be made between online information 502 and calendar information 402 (and additionally geographical information 302) to obtain a virtual location or a scheduled location (or a physical location), respectively. However, location source determination unit 114b, in conjunction with rules 116b, may alternatively be selecting from more or fewer than two (or three) location sources. For example implementations, online source 212 may produce and/or provide online information 502. Online information 502 and/or calendar information 402 (and/or geographical information 302) may correspond to logical ID 108 and/or user 106 (e.g., of FIG. 1). Although location source selection may be between online information 502 and geographical information 302 (or among online information 502, calendar information 402, and geographical information 302), an example implementation as described below pertains to a location source selection between online information 502 and calendar information 402 for the sake of clarity.

A location source (e.g., online source 212, calendar source 210, etc.) may be separate from where its corresponding location information (e.g., online information 502, calendar information 402, etc.) may be stored. Hence, location system 102 may be co-located with any (e.g., from none to all) of online source 212, calendar source 210 (e.g., of FIGS. 2 and 6), online information 502, calendar information 402, and so forth. By way of example only, a given device may include location system 102 and online source 212 (e.g., to ascertain online information 502), but such a device may remotely access calendar information 402 from a calendar source 210. Also by way of example only, a different given device may remotely access online information 502, but such a different device may include a local copy of calendar information 402. Still other devices may have local access to both or neither of online information 502 and calendar information 402. Other combinations for other devices may be implemented without departing from claimed subject matter. Different example device implementations are described further herein below with particular reference to FIGS. 11 and 12.

In an example operation, location source determination unit 114b may apply at least one parameter 602 to rules 116b. Parameter(s) 602 may comprise any one or more parameters, which may be implemented automatically, may be specified by a user, may be set by a service provider, may be established by an operator, may be stipulated by an online site/service (e.g., social networking, gaming, etc.) provider, some combination thereof, and so forth, just to name a few examples. By way of example only, a parameter 602 may comprise an identity of an entity submitting a request for location 110, a time of day when a location request is received, a current location of a user when a request is received, a combination thereof, and so forth. Additional examples and implementations for parameters 602 and rules 116 are described herein below with particular reference to FIG. 10.

Once parameter(s) 602 are applied to rules 116b, rules 116b may return or otherwise provide a selection indicator 604 to location source determination unit 114b. Selection indicator 604 may indicate which one (or ones) of multiple location sources is (or are) to be used to obtain a location 104 of a user. Location system 102 may select a location source based at least partially on selection indicator 604. For example, if selection indicator 604 indicates online information 502 (or, equivalently, online source 212), location system 102 may access online information 502 (or, equivalently, access online source 212) to obtain a virtual location. Alternatively, if selection indicator 604 indicates calendar information 402 (or, equivalently, calendar source 210), location system 102 may access calendar information 402 (or, equivalently, access calendar source 210) to obtain a scheduled location. Additionally or alternatively, location source determination unit 114b in conjunction with rules 116b may select between or among multiple different instances of calendar information 402 (e.g., a user may establish two or more different calendars or may establish two or more different entries for a single date/time in a one calendar).

After obtaining location 104 (e.g., virtual location 104c or scheduled location 104b (e.g., of FIGS. 2, 4, and 5)), obtained location 104 may be sent as part of or in association with location indication 112. Request for location 110 and/or location indication 112 may be received and/or transmitted by wire, by trace, wirelessly, etc., just to name a few examples. An identification of the source of the provided location may be included as part of or otherwise accompany location indication 112. For example, a virtual location may be tagged with an indication that the provided location is from online information and/or corresponds to an electronic location (e.g., in cyberspace). Alternatively, a scheduled location may be tagged with an indication that the provided location was retrieved from a calendar source and/or with an indication of when a specified location of a scheduled entry was most-recently updated.

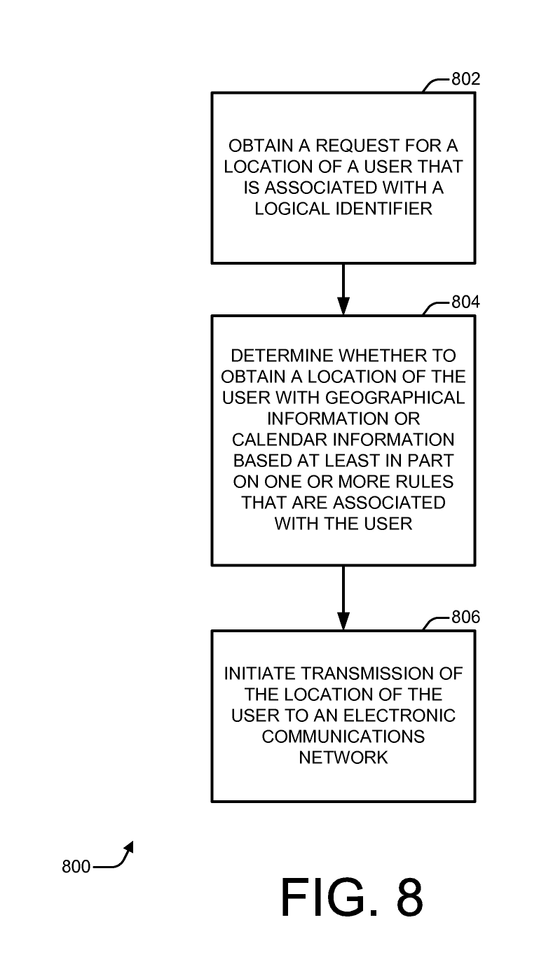

FIG. 8 is a flow diagram 800 illustrating an example method for providing a location indication in conjunction with a location source determination according to one implementation. As illustrated, flow diagram 800 includes three operational blocks 802, 804, and 806. Although operations 802-806 are shown and described in a particular order, it should be understood that methods may be performed in alternative manners without departing from claimed subject matter. Also, although the description below references aspects and features illustrated in certain other figures, methods may be performed with other aspects and/or features.

For certain example implementations, at operation 802, a request for a location of a user that is associated with a logical identifier may be obtained. For example, first electrical digital signals that are representative of a request for location 110 (e.g., of FIG. 6) of a user 106 that is associated with a logical ID 108 may be obtained from at least one communications medium and/or storage medium.

At operation 804, it may be determined whether to obtain a location of the user with geographical information or calendar information based at least in part on one or more rules that are associated with the user. For example, location source determination unit 114a may determine whether to obtain a location 104 of user 106 with geographical information 302 or with calendar information 402 based at least in part on one or more rules 116a that are associated with user 106.

At operation 806, transmission to an electronic communications network of the location of the user may be initiated. For example, transmission to an electronic communications network (e.g., on a wireless or wired link thereof) of second electrical digital signals, which are representative of a location 104 of user 106 (e.g., a location indication 112), may be initiated.

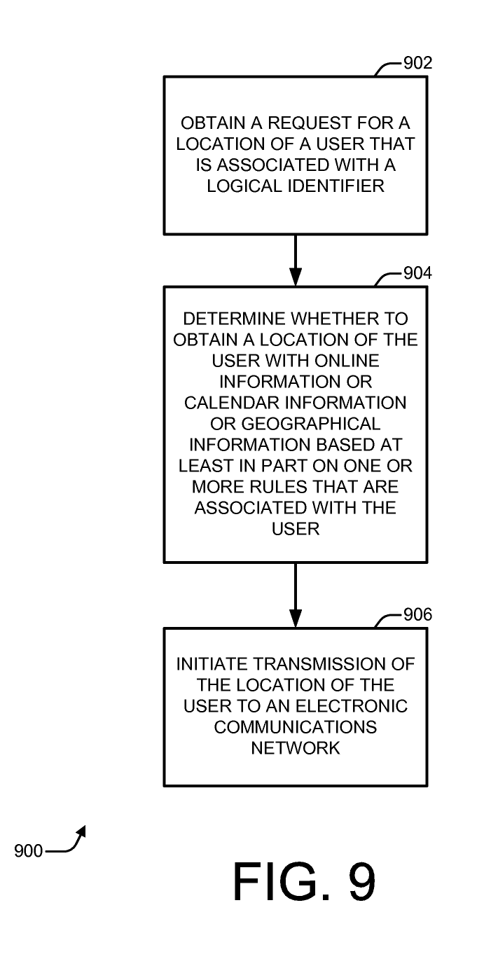

FIG. 9 is a flow diagram 900 illustrating an example method for providing a location indication in conjunction with a location source determination according to another implementation. As illustrated, flow diagram 900 includes three operational blocks 902, 904, and 906. Although operations 902-906 are shown and described in a particular order, it should be understood that methods may be performed in alternative manners without departing from claimed subject matter. Also, although the description below references aspects and features illustrated in certain other figures, methods may be performed with other aspects and/or features.

For certain example implementations, at operation 902, a request for a location of a user that is associated with a logical identifier may be obtained. For example, first electrical digital signals that are representative of a request for location 110 (e.g., of FIG. 7) of a user 106 that is associated with a logical ID 108 may be obtained from at least one communications medium and/or storage medium.

At operation 904, it may be determined whether to obtain a location of the user with online information or calendar information (or geographical information) based at least in part on one or more rules that are associated with the user. For example, location source determination unit 114b may determine whether to obtain a location 104 of user 106 with online information 502 or with calendar information 402 (or geographical information 302) based at least in part on one or more rules 116b that are associated with user 106.

At operation 906, transmission to an electronic communications network of the location of the user may be initiated. For example, transmission to an electronic communications network (e.g., on a wireless or wired link thereof) of second electrical digital signals, which are representative of a location 104 of user 106 (e.g., a location indication 112), may be initiated.

FIG. 10 is a block diagram illustrating an example mechanism 1000 for implementing location source selection rules according to an implementation. As illustrated, mechanism 1000 includes multiple operation blocks 1002, 1004, 1006, 1008, and 1010. Mechanism or logic 1000 may be used as an example algorithm to realize rules 116 (e.g., rules 116a of FIG. 6 and/or rules 116b of FIG. 7). Blocks 1004 (e.g., blocks 1004a-1004g) may be operative rule blocks that individually represent and/or implement at least one rule of rules 116. A user 106 (e.g., of FIG. 1) may be empowered to adjust (e.g., set, modify, activate, deactivate, establish, change, etc.) any rule as represented by operative rules 1004. A user 106 may adjust them locally at a device that includes and is to implement a location system 102 or may adjust them while remote from a given device that includes and is to implement a location system 102. Other entities (e.g., a service provider, a network operator, etc.) may also be empowered to adjust operative rules 1004.

In certain example implementations, mechanism 1000 may be initiated by providing (e.g., from a location source determination unit 114) one or more parameters 602 so as to implement rules for location source determination, as shown at block 1002. Parameter(s) 602 may be operated against rules 116 generally and/or operative rules 1004 specifically. Multiple operative rules 1004 are described further herein below. For an example implementation, however, operative rule 1004a is described below first. It should be understood that a given implementation may involve any one or more of operative rules 1004.

At operative rule 1004a, an identity of an entity that submitted a location request is considered in a location source determination analysis. For example, a user may want family members to receive a location obtained from a geographical source and co-workers to receive a location obtained from a calendar source. Requesting entities may be individually analyzed, or they may be analyzed by groups (e.g., grouped by email domain, grouped manually, grouped by contact category, etc.). In other words, a user may indicate a particular person (e.g., a spouse, a boss, etc.) is to be analyzed in a certain manner, or a user may indicate a group of people (e.g., a group of contacts jointly indicated to be family members, co-workers, etc.) is to be analyzed collectively in a certain manner. To ensure that intended recipients receive locations from intended location sources, an authentication requirement may be enacted (e.g., a previously-provided code may be required to be provided, a real-time inquiry may be made by a user, etc.). As indicated by flow arrow 1012, it may be determined at block 1008 whether more parameter(s) and/or more operative rules are to be considered in a location source determination analysis. If yes, then as indicated by flow arrow 1014 other operative rule(s) 1004 may be included in an analysis.

As noted above, additional and/or alternative operative rule(s) 1004 are described further herein below. Although not explicitly shown in FIG. 10 for other operative rules 1004 (e.g., as shown by way of example with flow arrow 1012 for operative rules 1004a, 1004b, and 1004e), operation(s) of block 1006 and/or 1008 may be performed after any (e.g., including none to all) of operative blocks 1004 are implemented. Also, multiple operative rules 1004 have arrows emanating there from and/or leading thereto. It should be understood, however, that these arrow(s) are illustrated by way of example only, and claimed subject matter is not so limited. Generally, rules 116 (e.g., of FIGS. 1, 6, and 7) may implement any number of operative rules 1004 in any order, including partially or fully simultaneously or overlapping. After two or more operative rules 1004 have been included in a location source determination rules analysis, one or more of corresponding parameters and/or rules may be weighted and/or prioritized as shown at block 1006. In other words, particular parameter(s) 602 and/or operative rule(s) 1004 may be weighted more or less heavily than others and/or prioritized over or under others. For example, a manual overall privacy mode may override an identity of a location requester.

If, on the other hand, no additional parameters and/or rules are to be factored into a location source determination rules analysis (as determined at block 1008), then at block 1010 a source for obtaining a location of a user may be selected. In example implementations, a location source may be selected based on considering one or more operative rules 1004, in conjunction with their corresponding one or more parameters 602 for a given factual situation, as weighted/prioritized in accordance with block 1006. A selected location source may be provided as at least part of selection indicator 604 from rules 116 to location source determination unit 114 (e.g., both from FIGS. 1, 6, and 7).

As noted above, any one or more of operative rules 1004 may be evaluated as part of an analysis of rules 116. Other examples of operative rules 1004, in addition to operative rule 1004a, are described below. At operative rule 1004b, a current day and/or a current time (e.g., at which request for location 110 is received) may be evaluated as at least part of a location source selection analysis. For example, a user may set an operative rule 1004b that specifies a particular location source is to be used over a defined time period (e.g., Monday-Friday from 8:00 am-5:00 pm a calendar source is used). As an example of two operative rules 1004a and 1004b both participating in a location source determination analysis, a user may set up these rules such that when a spouse calls between 5:00 pm and midnight, a selection indicator 604 is produced that indicates a location is to be obtained from a geographical source.

At operative rule 1004c, a logical ID that corresponds to a request for location may be evaluated as at least part of a location source selection analysis. For example, a single user may be associated with a first logical ID and a second logical ID. The first logical ID may relate to a work or public ID, and the second logical ID may relate to a personal or private ID. A user may establish operative rule 1004c such that location requests corresponding to a work or public ID are responded to with a location obtained from a calendar source, and location requests corresponding to a personal or private ID are responded to with a location obtained from a geographical source.

At operative rule 1004d, a current user location may be evaluated as at least part of a location source selection analysis. For example, a user may set up such an operative rule so that locations are obtained from a calendar source (e.g., instead of a geographical source) whenever a user is currently located at a basketball arena, or at a mall, or more than 10 miles from home, and so forth, just to name a few examples. As another multiple operative rule example, a user may establish operative rules such that a location system responds to location requests arriving between 6:00 pm and 10:00 pm on Tuesdays and Thursdays when a user's physical location is at home using an online source to provide a virtual location.

At operative rule 1004e, a privacy setting may be evaluated as at least part of a location source selection analysis. For example, a user may (e.g., manually) activate an overall privacy mode that causes a location system to respond to each incoming request for a location by obtaining a current location from a predetermined location source, such as a calendar source. As another example, a particular event (and/or scheduled time frame) may be marked as private. Based on operative rule 1004e, a location system may respond to location requests that arrive during such a particular private event by obtaining a current location from a predetermined location source (e.g., a secondary calendar source instead of a primary calendar source).

At operative rule 1004f, a location of an entity making a location request may be evaluated as at least a part of a location source selection analysis. For example, if a location of a requester is sufficiently proximate (e.g., within a predetermined, but definable, distance) to a current user location (as may be evaluated in accordance with operative rule 1004d), a location may be obtained from a geographical source. For instance, once a meeting participant nears a location of a user, the user's physical location may be provided to the meeting participant in lieu of another location type to facilitate arriving at a physical meeting place. On the other hand, a location requester may not have arranged for a meeting with a user. Hence, if such a location requestor is in the same building as the user when a location request is made, such a user may wish to provide a scheduled location so as not to reveal an exact or actual location. As another example, if a location requester's current location is provided as a virtual location, a location system may evaluate an operative rule 1004f such that a user's location is provided via an online source as virtual location.

At operative rule 1004g, a manual flag that may be set by a user may be evaluated as at least part of a location source selection analysis. For example, a user may manually set a flag that causes each incoming location request to automatically use calendar information to obtain a current location, to automatically use online information to obtain a current location, and so forth. For instance, a user may want location request responses to be based on online information if the user is going online. Alternatively, a user may want a location system to respond with a scheduled location while the user is enjoying a concert or other activity. As also indicated by the illustrated operative rule 1004g, other parameter(s) and/or operative rule(s) may additionally or alternatively be implemented as part of mechanism 1000 for rules 116.

Many alternative and/or additional factors/parameters may be evaluated in conjunction with operative rules for mechanism 1000. An example factor is whether a user manually updated a current location. For instance, a user may manually update a current location to indicate an upcoming meeting place. Another example factor is whether a device is currently being used. For instance, if a device is currently being used for reading or playing a game, an operative rule may cause a location to be obtained from calendar information. As another example factor, calendar information may not be used unless a location obtained there from matches an SPS-determined location. For instance, a scheduled location that is extracted from an entry in calendar information may not be provided to a requester unless the scheduled location is within a predetermined distance of recently-acquired SPS coordinates.

In certain example implementations, rules 116 may be evaluated to determine which location source from one or more locations sources can be selected to obtain a location of a user. Alternatively, in certain other example implementations, a particular location source may be selected as a default location source. Responsive to receipt of a request for location, rules 116 may be evaluated to determine whether a location source other than a default location source is to be selected. For example, calendar information may be established as default location information, and rules 116 may be evaluated to determine whether geographical information is to be use instead of the default. If so, then SPS functionality, for instance, may be activated to attain an SPS fix and acquire location coordinates. As another example, a user may establish first and second calendar information (e.g., a full first calendar and a full second calendar, one calendar with both first and second entries, some combination thereof, etc.). Such a user may designate first calendar information as default calendar information and indicate when second calendar information is to be used to obtain a location based on rules 116.

In other alternative example implementations, multiple types of location information may be accessed to obtain a (e.g., full) location in response to a received location request. For instance, calendar information may be consulted where the calendar information provides a location that specifies a particular online site and/or service 504 (e.g., of FIG. 5). A location system may then access the particular online site and/or service to ascertain a more-precise internal position 506. The particular online site/service 504 and the ascertained internal position 506 may be returned to a requesting entity as a location for a user.

In still other alternative example implementations, a feasibility check may be performed to ensure that proximate (e.g., adjacent) schedule entries in calendar information have locations that are possible for a user to be at each of the locations at the corresponding times. For instance, a location system may perform a feasibility check by comparing multiple locations corresponding to two or more entries of calendar information that are temporally proximate to one other. The comparison may verify whether it is possible for a user to be present at the multiple locations during the scheduled times of the corresponding two or more entries. Two or more entries may be temporally proximate if they are adjacent or otherwise sufficiently close in scheduled times such that a determination as to whether it is plausible for a user to travel between corresponding locations is implicated during such times. By way of example only, for two hour-long adjacent schedule entries, it might be expected that corresponding locations would be within a single city. Also, for two schedule entries that are four hours apart, two corresponding locations that are separated by 1000s of miles might seem implausible (unless a schedule entry indicates air travel).

In yet still other alternative example implementations, manufactured scatter may be added to locations provided from calendar information. The granularity of the scatter may vary based on times between location updates, content of schedule entries, combinations thereof, and so forth, just to name a few examples. Adding manufactured scatter to scheduled locations can provide the appearance of actual SPS coordinates. In still yet other alternative example implementations, a location may be reported in terms of a range or a distance area. For example, more or less precise locations (e.g., exact room versus general building versus campus, within 10 meters versus within 100 meters versus within 1 kilometer, etc.) may be provided by different sources and/or to different location requesters.

FIG. 11 depicts an example environment 1100 and multiple example devices in which location source determination may be implemented, according to an implementation. As illustrated, environment 1100 may include a telecommunications network 1102, an internet 1104, and five example devices 1106, 1108, 1110, 1112, and 1114. For certain example implementations, example devices in which location source determination may be implemented include, but are not limited to, a gateway 1106, a telecommunications node 1108, a website server 1110, a mobile device 1112, a fixed device 1114, a combination thereof, and so forth. Any of these devices may include and execute a location system application 102a.

In an example implementation, telecommunications network 1102 may include wireless and/or wired portions. Telecommunications network 1102 may include one or more telecommunications nodes 1108. Examples of telecommunications nodes 1108 include, but are not limited to, a base station (BS) node, a home location register (HLR) node, a general packet radio service (GPRS) core network node, a mobile switching center (MSC) node, a public-switched telephone network (PSTN) node, a radio network controller (RNC) node, a Node B, a serving GPRS support node (SGSN), a mobility management entity (MME) node, a serving gateway (SGW) node, a PDN gateway (PGW), a femtocell node, combinations thereof, and so forth.

Interconnecting telecommunications network 1102 and internet 1104 may be one or more gateways 1106 to facilitate communications having different protocols, timings, and so forth. Internet 1104 may include one or more servers, intelligent routers/switches, combinations thereof, and so forth, just to name a few examples. As indicated by website server 1110, such nodes of internet 1104 may include a location system application 102a. Although illustrated separately and interconnected via a gateway 1106, telecommunications network 1102 and internet 1104 may actually overlap in geographical location, functionality, constituent nodes, and so forth.

Environment 1100 also may include at least one fixed device 1114, which may be moved from time to time, but is generally connected by wire to a network, such as internet 1104. Fixed device 1114 may communicate by way of a wired communications medium or link 1116 with internet 1104. Examples of fixed devices 1114 include, but are not limited to, a desktop computer, a relatively large entertainment appliance (e.g., television, game console, etc.), a notebook computer that is connected to a LAN by cabling, combinations thereof, and so forth.

Environment 1100 also may include at least one mobile device 1112, which may be stationary, but is generally connected wirelessly to a network, such as telecommunications network 1102. Mobile device 1112 may communicate by way of a wireless communications medium or link 1118 with telecommunications network 1102 (or with internet 1104 via, e.g., a Wi-Fi or other wireless connection). Mobile devices 1112 may include, by way of example but not limitation, a mobile phone, a smart phone, a mobile station, a user equipment, a notebook computer, a netbook computer, a portable entertainment appliance (e.g., for reading, for game playing, for accessing the internet, etc.), a portable gaming machine, a navigational tool, combinations thereof, and so forth.

Mobile device 1112 and fixed device 1114 may include (e.g., store, execute, etc.) at least one location system application 102a. Similarly, gateway 1106, telecommunications node 1108, and website server 1110 may include at least one location system application 102a. Location system application 102a may implement functions, include features, provide information, etc. as described for location system 102 herein. Although five example devices 1106, 1108, 1110, 1112, and 1114 have been described herein, alternative and/or additional devices may implement one or more location systems 102. Hence, claimed subject matter is not limited to the illustrated and described devices. Example implementations for such devices are described herein below with particular reference to FIG. 12.

FIG. 12 is a schematic diagram illustrating an example device 1200, according to an implementation, that may implement one or more aspects for location source determination. As illustrated, device 1200 may include at least one processor 1202, one or more memories 1204, at least one communication interface 1206, at least one power source 1208, an SPS unit (SPSU) 1210, and other component(s) 1214. Memory 1204 is illustrated as including instructions 1212, which may include location system instructions 102b. However, a device 1200 may alternatively include more, fewer, and/or different components from those that are illustrated.

For certain example implementations, device 1200 may include and/or comprise an electronic device. Examples for device 1200 are described herein above with particular reference to FIG. 11; however, a device 1200 may further comprise any electronic device having at least one processor and/or memory. Nevertheless, device 1200 is described below, by way of example but not limitation, primarily in the context of a mobile device. Power source 1208 may provide power to the components and/or circuitry of device 1200. Power source 1208 may be a portable power source, such as a battery, or a fixed power source, such as an outlet in a car, house, or other building. Power source 1208 may be integrated with or separate from device 1200.

Processor 1202 may comprise any one or more processing units. Memory 1204 may contain location information from one or more location sources. It may also store all or part of rules 116 (e.g., when rules 116 are present on device 1200 and incorporated into or separate from location system instructions 102b). Memory 1204 may also be utilized to store instructions 1212 (e.g., a program, application, etc. or portion thereof; processor-executable instructions; code; some combination thereof; and so forth) that may be executable by processor 1202. Execution of such instructions 1212 by one or more processors 1202 may transform device 1200 into a special-purpose computing device, apparatus, platform, some combination thereof, and so forth.

Communication interface(s) 1206 may provide one or more interfaces between device 1200 and other devices (e.g., and/or human operators). Hence, communication interface 1206 may include a screen, speaker, keyboard or keys, or other human-device input/output feature(s). Communication interface 1206 may include a transceiver (e.g., transmitter and/or receiver), a radio, an antenna, a wired interface connector or other apparatus, some combination thereof, etc. to communicate wireless and/or wired signals (e.g., over wireless or wired communication links as described herein above with particular reference to FIG. 11). Communication interface 1206 may also serve as a bus or other interconnect between and/or among the other components of device 1200. Other component(s) 1214, if present, may comprise one or more other miscellaneous sensors, features, and so forth.

Methodologies described herein may be implemented by various means depending upon applications according to particular features and/or examples. For example, such methodologies may be implemented in hardware, firmware, software, discrete/fixed logic circuitry, any combination thereof, and so forth. In a hardware and/or logic circuitry implementation, for example, a processor/processing unit may be implemented within one or more application specific integrated circuits (ASICs), digital signal processors (DSPs), digital signal processing devices (DSPDs), programmable logic devices (PLDs), field programmable gate arrays (FPGAs), processors generally, controllers, micro-controllers, microprocessors, electronic devices, other devices or units designed to perform the functions described herein, and/or combinations thereof, just to name a few examples.

For a firmware and/or software implementation, the methodologies may be implemented with modules (e.g., procedures, functions, etc.) having instructions that perform the functions described herein. Any machine readable medium tangibly embodying instructions may be used in implementing the methodologies described herein. For example, software coding may be stored in a memory and executed by a processor. Memory may be implemented within the processor or external to the processor. As used herein the term “memory” refers to any type of long term, short term, volatile, nonvolatile, or other storage memory/medium and is not to be limited to any particular type of memory or number of memories, or type of media upon which memory is stored.

In one or more example implementations, the functions described may be implemented in hardware, software, firmware, discrete/fixed logic circuitry, some combination thereof, and so forth. If implemented in software, the functions may be stored on a physical computer-readable medium as one or more instructions or code. Computer-readable media include physical computer storage media. A storage medium may be any available physical medium that can be accessed by a computer. By way of example, and not limitation, such computer-readable media can comprise RAM, ROM, EEPROM, CD-ROM or other optical disc storage, magnetic disk storage or other magnetic storage devices, or any other medium that can be used to store desired program code in the form of instructions or data structures and that can be accessed by a computer and/or processor thereof. Disk and disc, as used herein, includes compact disc (CD), laser disc, optical disc, digital versatile disc (DVD), floppy disk and blu-ray disc, where disks usually reproduce data magnetically, while discs usually reproduce data optically with lasers.

Also, computer instructions/code may be transmitted via signals over physical transmission media from a transmitter to a receiver. For example, software may be transmitted from a website, server, or other remote source using a coaxial cable, fiber optic cable, twisted pair, digital subscriber line (DSL), or physical components of wireless technologies such as infrared, radio, and microwave. Combinations of the above may also be included within the scope of physical transmission media.

In an example implementation, SPSU 1210 may be capable of determining a location of device 1200 using an SPS system or systems. Hence, example implementations that are described herein may be used with various SPSs. Examples of SPSs may include, but are not limited to, the United States Global Positioning System (GPS), the Russian Glonass system, the European Galileo system, any system that uses satellites from a combination of satellite systems, any satellite system developed in the future, and so forth. Furthermore, implementations described herein may be used with positioning determination systems that utilize pseudolites or a combination of satellites and pseudolites. Pseudolites are usually ground-based transmitters that broadcast a Pseudo-Random Noise (PRN) code or other ranging code (e.g., similar to a GPS or CDMA cellular signal) that is modulated on an L-band (or other frequency) carrier signal, which may be synchronized with GPS time. Each such transmitter may be assigned a unique PN code so as to permit identification by a remote receiver. Pseudolites may be particularly useful in situations where GPS signals from an orbiting satellite might be unavailable, such as in tunnels, mines, buildings, urban canyons, or other enclosed areas. Another implementation of pseudolites is known as radio-beacons. The term “satellite”, as used herein, is also to include pseudolites, equivalents of pseudolites, and similar and/or analogous technologies. The term “SPS signals”, as used herein, is also to include SPS-like signals from pseudolites or equivalents of pseudolites.

Some portions of this Detailed Description are presented in terms of algorithms or symbolic representations of operations on binary digital signals stored within a memory of a specific apparatus or special purpose computing device or platform. In the context of this particular Specification, the term specific apparatus or the like includes a general purpose computer once it is programmed to perform particular functions pursuant to instructions from program software/instructions. Algorithmic descriptions or symbolic representations are examples of techniques used by those of ordinary skill in the signal processing or related arts to convey the substance of their work to others skilled in the art. An algorithm here, and generally, may be considered to be a self-consistent sequence of operations or similar signal processing leading to a desired result. In this context, operations or processing involve physical manipulation of physical quantities. Typically, although not necessarily, such quantities may take the form of electrical and/or magnetic signals capable of being stored, transferred, combined, compared, transmitted, received, or otherwise manipulated.

It has proven convenient at times, principally for reasons of common usage, to refer to such signals as bits, data, values, elements, symbols, characters, variables, terms, numbers, numerals, or the like. It should be understood, however, that all of these or similar terms are to be associated with appropriate physical quantities and are merely convenient labels. Unless specifically stated otherwise, as is apparent from the discussion above, it is appreciated that throughout this Specification discussions utilizing terms such as “processing,” “computing,” “calculating,” “determining,” “ascertaining,” “identifying,” “associating,” “obtaining,” “performing,”, “initiating,”, “analyzing,” or the like refer to actions or processes of a specific apparatus, such as a special purpose computer or a similar special purpose electronic computing device. In the context of this Specification, therefore, a special purpose computer or a similar special purpose electronic computing device is capable of manipulating or transforming signals, typically represented as physical electronic, electrical, and/or magnetic quantities within memories, registers, or other information storage devices, transmission devices, or display devices of the special purpose computer or similar special purpose electronic computing device.

While there has been illustrated and described what are presently considered to be example features, it will be understood by those skilled in the art that various other modifications may be made, and equivalents may be substituted, without departing from claimed subject matter. Additionally, many modifications may be made to adapt a particular situation to the teachings of claimed subject matter without departing from the central concepts described herein. Therefore, it is intended that claimed subject matter not be limited to the particular examples disclosed, but that such claimed subject matter may also include all aspects falling within the scope of appended claims, and equivalents thereof.

What is claimed is:

1. A method comprising:
obtaining a request for a location of a user that is associated with a logical identifier;
determining whether to obtain a location of said user with geographical information or calendar information based at least in part on one or more rules that are associated with said user; and
initiating transmission of said location of said user to an electronic communications network.

2. The method of claim 1, further comprising:
obtaining said location of said user with said geographical information or said calendar information responsive to said determining.

3. The method of claim 1, further comprising:
obtaining said location of said user with said geographical information by activating satellite positioning system (SPS) functionality to ascertain a physical location of said user.

4. The method of claim 1, further comprising:
obtaining said location of said user with said calendar information by accessing said calendar information and retrieving a scheduled location corresponding to a current schedule entry.

5. The method of claim 1, wherein said determining whether to obtain a location comprises:
applying at least one parameter to said one or more rules that are associated with said user; and
selecting said geographical information or said calendar information for determining said location of said user based at least in part on said at least one parameter.

6. The method of claim 5, wherein said at least one parameter comprises an identity of an entity submitting said request for said location of said user.

7. The method of claim 5, wherein said at least one parameter comprises one or more parameters selected from a group comprising: time of day, identity of location requester, location of location requester, current user location, or logical identifier corresponding to said request for said location of said user.

8. The method of claim 1, further comprising:
determining which schedule entry from at least two schedule entries, which have an overlapping date-time range, is to be used to obtain said location of said user based at least in part on said one or more rules that are associated with said user.

9. The method of claim 1, further comprising:
selecting from at least two schedule entries of said calendar information based at least in part on one or more tags or on actual location.

10. The method of claim 1, further comprising:
performing a feasibility check by comparing multiple locations corresponding to two or more entries of said calendar information that are temporally proximate to each other to verify that it is possible for said user to be present at said multiple locations during scheduled times of said corresponding two or more entries.

11. The method of claim 1, further comprising:
storing a bookmarked location by activating satellite positioning system (SPS) functionality to ascertain a current physical location of said user; and
including said bookmarked location in a schedule entry of calendar information associated with said user.

12. The method of claim 1, wherein said initiating transmission further comprises:
initiating transmission of an indication that said location of said user is based on calendar information when said location is determined to be obtained with said calendar information.

13. The method of claim 1, wherein said determining further comprises:
determining whether to obtain said location of said user with said geographical information, said calendar information, or online information based at least in part on said one or more rules that are associated with said user.

14. The method of claim 13, further comprising:
obtaining said location of said user with said online information by accessing said online information and retrieving a virtual location of said user.

15. The method of claim 13, further comprising:
obtaining said location of said user with said online information by accessing said online information and retrieving a virtual location of said user based on a current presence indication, said virtual location corresponding to an electronic site or service.

16. The method of claim 15, wherein said virtual location further corresponds to an internal position of said electronic site or service.

17. A device comprising:
at least one memory configured to store instructions; and
one or more processors to execute said instructions and render the device a special purpose computing device to:
obtain a request for a location of a user that is associated with a logical identifier;
determine whether to obtain a location of said user with geographical information or calendar information based at least in part on one or more rules that are associated with said user; and
initiate transmission of said location of said user to an electronic communications network.

18. The device of claim 17, wherein said one or more processors are further to execute said instructions and render the device a special purpose computing device to:
obtain said location of said user with said geographical information or said calendar information responsive to said determining.

19. The device of claim 17, wherein said one or more processors are further to execute said instructions and render the device a special purpose computing device to:
obtain said location of said user with said geographical information by activating satellite positioning system (SPS) functionality to ascertain a physical location of said user.

20. The device of claim 17, wherein said one or more processors are further to execute said instructions and render the device a special purpose computing device to:
obtain said location of said user with said calendar information by accessing said calendar information and retrieving a scheduled location corresponding to a current schedule entry.

21. The device of claim 17, wherein to determine whether to obtain a location said one or more processors are further to execute said instructions to:
apply at least one parameter to said one or more rules that are associated with said user; and
select said geographical information or said calendar information for determining said location of said user based at least in part on said at least one parameter.

22. The device of claim 21, wherein said at least one parameter comprises an identity of an entity submitting said request for said location of said user.

23. The device of claim 21, wherein said at least one parameter comprises one or more parameters selected from a group comprising: time of day, identity of location requester, location of location requester, current user location, or logical identifier corresponding to said request for said location of said user.

24. The device of claim 17, wherein said one or more processors are further to execute said instructions and render the device a special purpose computing device to:
determine which schedule entry from at least two schedule entries, which have an overlapping date-time range, is to be used to obtain said location of said user based at least in part on said one or more rules that are associated with said user.

25. The device of claim 17, wherein said one or more processors are further to execute said instructions and render the device a special purpose computing device to:
select from at least two schedule entries of said calendar information based at least in part on one or more tags or on actual location.

26. The device of claim 17, wherein said one or more processors are further to execute said instructions and render the device a special purpose computing device to:
perform a feasibility check by comparing multiple locations corresponding to two or more entries of said calendar information that are temporally proximate to each other to verify that it is possible for said user to be present at said multiple locations during scheduled times of said corresponding two or more entries.

27. The device of claim 17, wherein said one or more processors are further to execute said instructions and render the device a special purpose computing device to:
store a bookmarked location by activating satellite positioning system (SPS) functionality to ascertain a current physical location of said user; and
include said bookmarked location in a schedule entry of calendar information associated with said user.

28. The device of claim 17, wherein to initiate transmission said one or more processors are further to execute said instructions to:
initiate transmission of an indication that said location of said user is based on calendar information when said location is determined to be obtained with said calendar information.

29. The device of claim 17, wherein to determine whether to obtain a location said one or more processors are further to execute said instructions to:
determine whether to obtain said location of said user with said geographical information, said calendar information, or online information based at least in part on said one or more rules that are associated with said user.

30. The device of claim 29, wherein said one or more processors are further to execute said instructions and render the device a special purpose computing device to:
obtain said location of said user with said online information by accessing said online information and retrieving a virtual location of said user.

31. The device of claim 29, wherein said one or more processors are further to execute said instructions and render the device a special purpose computing device to:
obtain said location of said user with said online information by accessing said online information and retrieving a virtual location of said user based on a current presence indication, said virtual location corresponding to an electronic site or service.

32. The device of claim 31, wherein said virtual location further corresponds to an internal position of said electronic site or service.

33. An apparatus comprising:
means for obtaining a request for a location of a user that is associated with a logical identifier;
means for determining whether to obtain a location of said user with geographical information or calendar information based at least in part on one or more rules that are associated with said user; and
means for initiating transmission of said location of said user to an electronic communications network.

34. The apparatus of claim 33, further comprising:
means for obtaining said location of said user with said geographical information or said calendar information responsive to said determining.

35. The apparatus of claim 33, further comprising:
means for obtaining said location of said user with said geographical information by activating satellite positioning system (SPS) functionality to ascertain a physical location of said user.

36. The apparatus of claim 33, further comprising:
means for obtaining said location of said user with said calendar information by accessing said calendar information and retrieving a scheduled location corresponding to a current schedule entry.

37. The apparatus of claim 33, wherein said means for determining whether to obtain a location comprises:
means for applying at least one parameter to said one or more rules that are associated with said user; and
means for selecting said geographical information or said calendar information for determining said location of said user based at least in part on said at least one parameter.

38. The apparatus of claim 37, wherein said at least one parameter comprises an identity of an entity submitting said request for said location of said user.

39. The apparatus of claim 37, wherein said at least one parameter comprises one or more parameters selected from a group comprising: time of day, identity of location requester, location of location requester, current user location, or logical identifier corresponding to said request for said location of said user.

40. The apparatus of claim 33, further comprising:
means for determining which schedule entry from at least two schedule entries, which have an overlapping date-time range, is to be used to obtain said location of said user based at least in part on said one or more rules that are associated with said user.

41. The apparatus of claim 33, further comprising:
means for selecting from at least two schedule entries of said calendar information based at least in part on one or more tags or on actual location.

42. The apparatus of claim 33, further comprising:
means for performing a feasibility check by comparing multiple locations corresponding to two or more entries of said calendar information that are temporally proximate to each other to verify that it is possible for said user to be present at said multiple locations during scheduled times of said corresponding two or more entries.

43. The apparatus of claim 33, further comprising:
means for storing a bookmarked location by activating satellite positioning system (SPS) functionality to ascertain a current physical location of said user; and
means for including said bookmarked location in a schedule entry of calendar information associated with said user.

44. The apparatus of claim 33, wherein said means for initiating transmission further comprises:
means for initiating transmission of an indication that said location of said user is based on calendar information when said location is determined to be obtained with said calendar information.

45. The apparatus of claim 33, wherein said means for determining further comprises:
means for determining whether to obtain said location of said user with said geographical information, said calendar information, or online information based at least in part on said one or more rules that are associated with said user.

46. The apparatus of claim 45, further comprising:
means for obtaining said location of said user with said online information by accessing said online information and retrieving a virtual location of said user.

47. The apparatus of claim 45, further comprising:
means for obtaining said location of said user with said online information by accessing said online information and retrieving a virtual location of said user based on a current presence indication, said virtual location corresponding to an electronic site or service.

48. The apparatus of claim 47, wherein said virtual location further corresponds to an internal position of said electronic site or service.

49. An article comprising:
at least one storage medium having stored thereon instructions executable by one or more processors to:
obtain a request for a location of a user that is associated with a logical identifier;
determine whether to obtain a location of said user with geographical information or calendar information based at least in part on one or more rules that are associated with said user; and
initiate transmission of said location of said user to an electronic communications network.

50. The article of claim 49, wherein said at least one storage medium has stored thereon further instructions executable by one or more processors to:
obtain said location of said user with said geographical information or said calendar information responsive to said determining.

51. The article of claim 49, wherein said at least one storage medium has stored thereon further instructions executable by one or more processors to:
obtain said location of said user with said geographical information by activating satellite positioning system (SPS) functionality to ascertain a physical location of said user.

52. The article of claim 49, wherein said at least one storage medium has stored thereon further instructions executable by one or more processors to:
obtain said location of said user with said calendar information by accessing said calendar information and retrieving a scheduled location corresponding to a current schedule entry.

53. The article of claim 49, wherein to determine whether to obtain a location said at least one storage medium has stored thereon further instructions executable by one or more processors to:
apply at least one parameter to said one or more rules that are associated with said user; and
select said geographical information or said calendar information for determining said location of said user based at least in part on said at least one parameter.

54. The article of claim 53, wherein said at least one parameter comprises an identity of an entity submitting said request for said location of said user.

55. The article of claim 53, wherein said at least one parameter comprises one or more parameters selected from a group comprising: time of day, identity of location requester, location of location requester, current user location, or logical identifier corresponding to said request for said location of said user.

56. The article of claim 49, wherein said at least one storage medium has stored thereon further instructions executable by one or more processors to:
determine which schedule entry from at least two schedule entries, which have an overlapping date-time range, is to be used to obtain said location of said user based at least in part on said one or more rules that are associated with said user.

57. The article of claim 49, wherein said at least one storage medium has stored thereon further instructions executable by one or more processors to:
select from at least two schedule entries of said calendar information based at least in part on one or more tags or on actual location.

58. The article of claim 49, wherein said at least one storage medium has stored thereon further instructions executable by one or more processors to:
perform a feasibility check by comparing multiple locations corresponding to two or more entries of said calendar information that are temporally proximate to each other to verify that it is possible for said user to be present at said multiple locations during scheduled times of said corresponding two or more entries.

59. The article of claim 49, wherein said at least one storage medium has stored thereon further instructions executable by one or more processors to:
store a bookmarked location by activating satellite positioning system (SPS) functionality to ascertain a current physical location of said user; and
include said bookmarked location in a schedule entry of calendar information associated with said user.

60. The article of claim 49, wherein to initiate transmission said at least one storage medium has stored thereon further instructions executable by one or more processors to:
initiate transmission of an indication that said location of said user is based on calendar information when said location is determined to be obtained with said calendar information.

61. The article of claim 49, wherein to determine whether to obtain a location said at least one storage medium has stored thereon further instructions executable by one or more processors to:
determine whether to obtain said location of said user with said geographical information, said calendar information, or online information based at least in part on said one or more rules that are associated with said user.

62. The article of claim 61, wherein said at least one storage medium has stored thereon further instructions executable by one or more processors to:
obtain said location of said user with said online information by accessing said online information and retrieving a virtual location of said user.

63. The article of claim 61, wherein said at least one storage medium has stored thereon further instructions executable by one or more processors to:
obtain said location of said user with said online information by accessing said online information and retrieving a virtual location of said user based on a current presence indication, said virtual location corresponding to an electronic site or service.

64. The article of claim 63, wherein said virtual location further corresponds to an internal position of said electronic site or service.
